(19) United States
(12) Patent Application Publication
(10) Pub. No.: US 2025/0158424 A1
(43) Pub. Date: May 15, 2025

(54) BATTERY CONTROL SYSTEM AND METHOD

(71) Applicant: SAMSUNG SDI CO., LTD., Yongin-si (KR)

(72) Inventor: Taeseong CHOI, Yongin-si (KR)

(21) Appl. No.: 18/608,789

(22) Filed: Mar. 18, 2024

(30) Foreign Application Priority Data
Nov. 15, 2023 (KR) 10-2023-0158662

(51) Int. Cl. H02J 7/00

(52) U.S. Cl. CPC H02J 7/0016; H02J 7/0018; H02J 7/0048; H02J 7/005; H02J 7/00712

(57) ABSTRACT

A battery control method for controlling a battery system including a plurality of battery racks in a battery control system, includes: receiving operation mode information of the battery system from an energy management system; receiving status information of the battery system from the battery system; determining an individual power of each of the plurality of battery racks based on the operation mode information and the status information; and adjusting the individual powers of the plurality of battery racks if at least one of the plurality of battery racks has the individual power that exceeds a maximum power of a corresponding battery rack from among the plurality of battery racks.

### CROSS-REFERENCE TO RELATED APPLICATION

The present application claims priority to and the benefit of Korean Patent Application No. 10-2023-0158662, filed on Nov. 15, 2023, in the Korean Intellectual Property Office, the entire disclosure of which is incorporated by reference herein.

### BACKGROUND

### 1. Field

Aspects of embodiments of the present disclosure relate to a battery control system and method.

### 2. Description of the Related Art

An energy storage system may improve energy efficiency by storing remaining power in a battery system when power demand is low, and then using the power stored in the battery system when power demand is high.

The battery system may include a plurality of battery racks connected in parallel to achieve a large power storage capacity. The battery rack may include a plurality of battery modules, and each battery module may include a plurality of cells connected in series and/or parallel. In such battery system, a voltage deviation or a capacity deviation between battery racks may occur due to various factors, such as process errors between the battery racks and unbalanced temperature distribution between the battery racks. These differences in characteristics may cause adverse effects on the energy storage system, such as reduced battery usable capacity, inrush current, overcharge, overdischarge, overcurrent, heat generation, and/or thermal runaway. Therefore, a method for efficiently operating an energy storage system may be desired, considering the differences in the characteristics between the battery racks.

The above information disclosed in this Background section is for enhancement of understanding of the background of the present disclosure, and therefore, it may contain information that does not constitute prior art.

### SUMMARY

One or more embodiments of the present disclosure may be directed to a battery control system and method that can efficiently operate an energy storage system.

According to one or more embodiments of the present disclosure, a battery control method for controlling a battery system including a plurality of battery racks in a battery control system, includes: receiving operation mode information of the battery system from an energy management system; receiving status information of the battery system from the battery system; determining an individual power of each of the plurality of battery racks based on the operation mode information and the status information; and adjusting the individual powers of the plurality of battery racks if at least one of the plurality of battery racks has the individual power that exceeds a maximum power of a corresponding battery rack from among the plurality of battery racks.

In an embodiment, the adjusting of the individual powers of the plurality of battery racks may include: determining a power correction coefficient based on the individual powers of the plurality of battery racks and maximum powers of the plurality of battery racks; and correcting the individual powers of the plurality of battery racks by reflecting the power correction coefficient to the individual powers of the plurality of battery racks.

In an embodiment, the determining of the power correction coefficient may include: calculating a ratio of the individual power to the maximum power of each of the plurality of battery racks; and determining a smallest value from among the ratios of the individual powers to the maximum powers of the plurality of battery racks as the power correction coefficient.

In an embodiment, if the operation mode information indicates a charge mode, the individual power may indicate a charging power; and if the operation mode information indicates a discharge mode, the individual power may indicate a discharging power.

In an embodiment, the operation mode information may include at least one of charge mode information or discharge mode information; and the status information may include at least one of a status of charge (SOC), a status of health (SOH), or a depth of discharge (DOD) of each of the plurality of battery racks.

In an embodiment, the charge mode information may include a total charging power of the battery system, and the determining of the individual power may include: determining a target charging coefficient representing a charging rate of each of the plurality of battery racks using the DOD and the SOH of each of the plurality of battery racks; and calculating an individual charging power of each of the plurality of battery racks based on the total charging power of the battery system and the target charging coefficient of each of the plurality of battery racks.

In an embodiment, the discharge mode information may include a total discharging power of the battery system, and the determining of the individual power may include: determining a target discharging coefficient representing a discharge rate of each of the plurality of battery racks using the SOC and the SOH of each of the plurality of battery racks; and calculating an individual discharging power of each of the plurality of battery racks based on the total discharging power of the battery system and the target discharging coefficient of each of the plurality of battery racks.

According to one or more embodiments of the present disclosure, a battery control system to control a battery system including a plurality of battery racks, includes: a communicator configured to receive operation mode information of the battery system and status information of the battery system; an operation mode determiner configured to determine an operation mode of the battery system based on the operation mode information; and a power calculator configured to: determine an individual power of each of the plurality of battery racks corresponding to the operation mode based on the status information; and determine whether to adjust the individual power of each of the plurality of battery racks based on the individual power of each of the plurality of battery racks and a maximum power of each of the plurality of battery racks.

In an embodiment, the power calculator may be configured to determine final powers of the plurality of battery racks by adjusting the individual powers of the plurality of battery racks if at least one of the plurality of battery racks has the individual power that exceeds a maximum power of a corresponding battery rack.

In an embodiment, the power calculator may be configured to: determine a power correction coefficient based on the individual powers of the plurality of battery racks and maximum powers of the plurality of battery racks; and reflect the power correction coefficient to the individual powers of the plurality of battery racks to determine the final powers of the plurality of battery racks.

In an embodiment, the power calculator may be configured to: calculate a ratio of the individual power to the maximum power of each of the plurality of battery racks; and determine a smallest value of the ratios of the individual powers to the maximum powers of the plurality of battery racks as the power correction coefficient.

In an embodiment, the power calculator may be configured to determine the individual power of each of the plurality of battery racks as the final power of each of the plurality of battery racks, respectively, if the individual power of each of the plurality of battery racks does not exceed the maximum power of each of the plurality of battery racks.

In an embodiment, the operation mode information may include at least one of charge mode information or discharge mode information; and the status information may include at least one of a status of charge (SOC), a status of health (SOH), or a depth of discharge (DOD) of each of the plurality of battery racks.

In an embodiment, the charge mode information may include a total charging power of the battery system, and the power calculator may be configured to: determine a target charging coefficient representing a charging rate of each of the plurality of battery racks using the DOD and the SOH of each of the plurality of battery racks; and calculate an individual charging power of each of the plurality of battery racks based on the total charging power of the battery system and the target charging coefficient of each of the plurality of battery racks.

In an embodiment, the discharge mode information may include a total discharging power of the battery system, and the power calculator may be configured to: determine a target discharging coefficient representing a discharge rate of each of the plurality of battery racks using the SOC and the SOH of each of the plurality of battery racks; and calculate an individual discharging power of each of the plurality of battery racks based on the total discharging power of the battery system and the target discharging coefficient of each of the plurality of battery racks.

However, the aspects and features of the present disclosure are not limited to those described above. The above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a diagram illustrating an energy storage system according to an embodiment.

FIG. 2 is a diagram illustrating an energy storage system according to an embodiment.

FIG. 3 is a diagram illustrating an example of the battery system shown in FIG. 2.

FIG. 4 is a flowchart illustrating a method of determining the charging power of each battery rack in the battery control system shown in FIG. 2.

FIG. 5 is a flowchart illustrating a method of determining the discharging power of each battery rack in the battery control system shown in FIG. 2.

FIG. 6 is a diagram illustrating a battery control system according to an embodiment.

FIG. 7 is a diagram illustrating a battery control system according to another embodiment.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

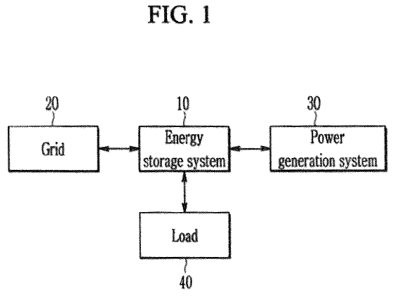

FIG. 1 is a diagram illustrating an energy storage system according to an embodiment.

Referring to FIG. 1, an energy storage system 10 may be a system that stores electrical energy, and uses the stored energy when needed. For example, the energy storage system 10 may store surplus power from among the power supplied from a grid 20 at night during which power usage is low, and may provide the stored power to a load 40 during the day when power usage is a peak value.

The energy storage system 10 may store power produced by the grid 20 or a power generation system 30, and may supply the stored power to the load 40 or provide surplus power to the grid 20.

The grid 20 may include a power plant, a substation, a transmission station, and/or the like. In a normal state, the grid 20 may supply power to the energy storage system 10 to operate the load 40, and may receive power produced from the power generation system 30.

The power generation system 30 may be a system that generates power using an energy source. The power generation system 30 may provide the generated power to the energy storage system 10. The power generation system 30 may be a solar power generation system, a wind power generation system, a tidal power generation system, and/or the like, but the present disclosure is not limited to the kinds of power generation systems described above.

The load 40 may consume power supplied from the energy storage system 10. For example, various electrical equipment installed in factories, homes, and/or the like may correspond to the load 40.

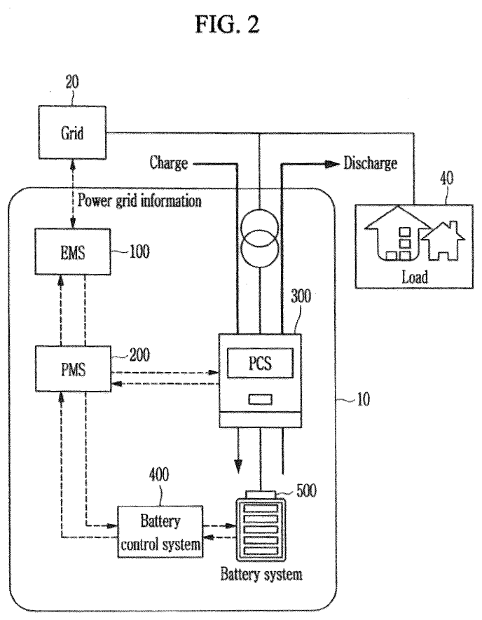

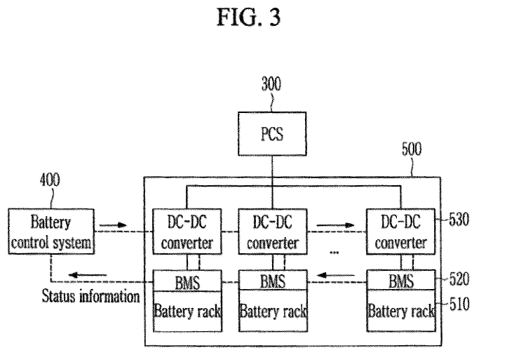

FIG. 2 is a diagram illustrating an energy storage system according to an embodiment. FIG. 3 is a diagram illustrating an example of the battery system shown in FIG. 2.

Referring to FIG. 2, the energy storage system 10 may include an energy management system (EMS) 100, a power management system (PMS) 200, a power conversion system (PCS) 300, a battery control system 400, and a battery system 500.

Information may be transmitted and received between the battery system 500, the battery control system 400, the PMS 200, and the PCS 300 through a communication using a controller area network (CAN) or ethernet.

The battery system 500 may be charged by receiving power from the grid 20 or the power generation system 30, and may be discharged to supply power to the load 40 or the grid 20.

Referring to FIG. 3, the battery system 500 may include a plurality of battery racks 510, a plurality of battery management systems (BMS) 520, and a plurality of DC-DC converters 530.

The battery rack 510 may include a plurality of battery modules electrically connected to each other in series and/or parallel. Each battery module may include a plurality of cells electrically connected to each other in series and/or parallel. The battery rack 510 may be referred to as a battery pack or a battery module according to the device or system in which the battery system 500 is used.

The BMS 520 may be installed in each of the plurality of battery racks 510.

The plurality of BMSs 520 may each be connected to the plurality of battery racks 510, and monitor the plurality of battery racks 510. The plurality of BMSs 520 may each measure and collect status information of a corresponding battery rack 510, such as a current, a voltage, a temperature, a status of charge (SOC), a status of health (SOH), a depth of discharge (DOD), a maximum power, and a capacity, and may provide the status information of the corresponding battery rack 510 to the battery control system 400. Additionally, the plurality of BMSs 520 may control charging and discharging of the plurality of battery racks 510 based on the status information of the plurality of battery racks 510, and may perform a balancing operation.

The plurality of DC-DC converters 530 may be connected to the plurality of battery racks 510, respectively. By connecting a corresponding DC-DC converter 530 to a corresponding one of each of the plurality of battery racks 510, individual control of the plurality of battery racks 510 may be possible based on the final charging power and/or final discharging power of each of the plurality of battery racks 510 as determined by the battery control system 400.

The plurality of DC-DC converters 530 may be connected in parallel to the PCS 300 through a DC link. The plurality of DC-DC converters 530 may convert the power received from the PCS 300 into power for charging the plurality of battery rack 510, based on the final charging power of the plurality of the battery racks 510 as determined by the battery control system 400 in the charge mode, and may supply the converted power to the plurality of battery racks 510, respectively. Each of the plurality of DC-DC converters 530 may convert the power discharged from the plurality of battery racks 510 into power for an external supply, based on the final discharging power of the plurality of battery racks 510 in the discharge mode. The plurality of DC-DC converters 530 may minimize or reduce a power consumption by stopping operation in an idle mode that does not use charging or discharging of the battery system 100. As such, the DC-DC converters 530 may be used as various kinds of converters, such as a full-bridge converter, a half-bridge converter, and a flyback converter.

Referring again to FIG. 2, the EMS 100 may receive power grid information, such as rate information, power usage, and environmental information, and may control the energy storage system 10 according to the user's energy production, storage, and consumption patterns.

The EMS 100 may monitor the status of the grid 20, the power generation system 30, the PMS 200, and the battery system 500. The EMS 100 may monitor the amount of power stored in the energy storage system 10. The EMS 100 may determine the total charging power and total discharging power of the energy storage system 10 based on the amount of power generated in the grid 20 or the power generation system 30 and the amount of power stored in the energy storage system 10, and determine the operating mode of the energy storage system 10. The operating mode may include, for example, a charge mode, a discharge mode, and a rest mode. As an example, the EMS 100 may determine whether to charge and/or discharge the battery system 100 through a difference between the amount of power delivered from the battery system 500 to the load 40 and the amount of power generated by the grid 20 or the power generation system 30, and may determine the operation mode depending on whether to charge and/or discharge the battery system 100.

The EMS 100 may manage data, such as total charging power, total discharging power, and operation history, of the energy storage system 10. The EMS 100 may operate the energy storage system 10, and may be an operating system for controlling the energy storage system 10.

The PMS 200 may operate according to the control of the EMS 100. The PMS 200 may monitor the battery system 500 and the PCS 300, and control the battery system 500 and the PCS 300. The PMS 200 may receive status information of the battery system 500 from the battery control system 400, and may report the status information of the battery system 500 to the EMS 100. The PMS 200 may transmit, to the PCS 300 and the battery control system 400, an operation command to the charge mode, an operation command to the discharge mode, or an operation command to the rest mode, based on the control of the EMS 100. The operation command may include information desired for the corresponding operation mode. For example, in a charge mode, the operation command to the charge mode may include information indicating the charge mode, and the total charging power of the energy storage system 10. In a discharge mode, the operation command to the discharge mode may include information indicating the discharge mode, and the total discharging power of the energy storage system 10.

In some embodiments, the EMS 100 and the PMS 200 may be integrated with each other into one system. For example, the EMS 100 may perform the function of the PMS 200, and in this case, the PMS 200 may be omitted.

The PCS 300 may be connected to the grid 20, the power generation system 30, and the load 40. The PCS 300 may be further connected to battery system 500. The PCS 300 may control power supplied from the outside, and may control power supplied from the battery system 500 to the outside.

The PCS (300) may control a power distribution of the plurality of battery racks 510 according to the control of the PMS 200. The PCS 300 may start the charge mode or the discharge mode and end the charge mode or the discharge mode under the control of the PMS 200. In the charge mode, the PCS 300 may distribute the power supplied from the outside to the plurality of battery racks 510 based on the final charging power of each battery rack in the energy storage system 10. As an example, the PCS 300 may distribute the power supplied from the grid 20 to the plurality of battery racks 510. In the discharge mode, the PCS 300 may supply the final discharging power of each battery rack to the outside based on the final discharging power of each battery rack within the energy storage system 10.

The PCS 300 may maintain the voltage of the DC link to be constant or substantially constant by discharging or charging the power of the battery system 500.

The PCS 300 may convert power characteristics between the battery system 500 and the power generation system 30, and between the battery system 500 and the grid 20. The power characteristics may include a frequency, a voltage, a current, an alternating current (AC), a direct current (DC), and/or the like. As an example, the PCS 300 may convert AC power supplied from the grid 20 into DC power, and supply the converted DC power to the battery system 500. As another example, the PCS 300 may convert DC power supplied from the battery system 500 into AC power, and supply the converted AC power to the load 40.

The battery control system 400 may manage the battery system 500. The battery control system 400 may monitor the voltage and the charging state of the battery racks 510, maintain or substantially maintain balancing between the battery racks 510, and prevent or substantially prevent the battery racks 510 from being overcharged.

The battery control system 400 may determine the final charging power of each battery rack 510 based on the status information of each battery rack 510 and the total charging power of the energy storage system 10. The sum of the final charging power of the plurality of battery racks 510 may be equal to the total charging power of the energy storage system 10.

The battery control system 400 may determine the final discharging power of each battery rack 510 based on the status information of each battery rack 510 and the total discharging power of the energy storage system 10. The sum of the final discharging power of the plurality of battery racks 510 may be equal to the total discharging power of the energy storage system 10.

According to an embodiment, the battery control system 400 may monitor the status of the battery racks 510, and resolve a capacity imbalance between the battery racks 510 through individual control of the battery racks 510.

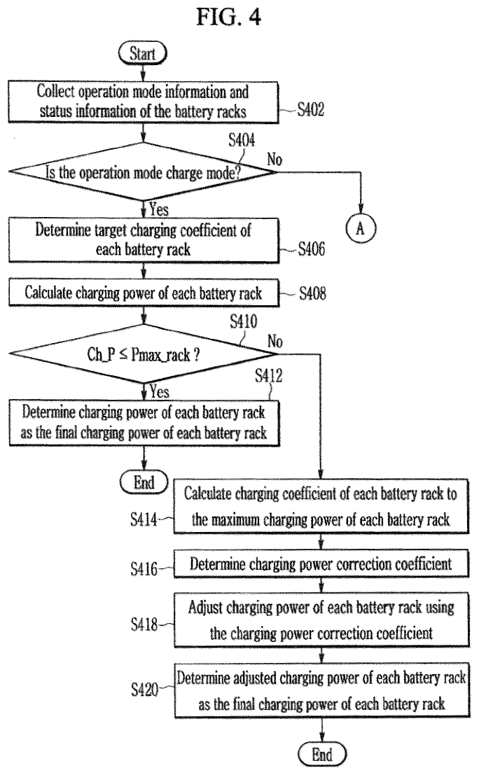

FIG. 4 is a flowchart illustrating a method of determining the charging power of each battery rack in the battery control system shown in FIG. 2.

Referring to FIG. 4, the battery control system 400 may collect operation mode information and status information of the battery racks 510 (S402). The battery control system 400 may receive operation mode information from the EMS 100 through the PMS 200, and may receive status information of each battery rack 510 from each BMS 520.

The battery control system 400 may determine the operation mode based on the operation mode information. In FIG. 4, the operation mode may be a charge mode.

When the battery control system 400 determines that the operation mode is the charge mode based on the operation mode information (S404), the battery control system 400 may determine a target charging coefficient of each battery rack 510 using a total charging power of the energy storage system 10 and the status information of each battery rack 510 (S406). For example, the operation mode information may include information indicating the charge mode and the total charging power of the energy storage system 10. In this case, the battery control system 400 may determine that the operation mode is the charge mode. For another example, the operation mode information may include information indicating the discharge mode and the total discharging power of the energy storage system 10. In this case, the battery control system 400 may determine that the operation mode is the discharge mode.

The battery control system 400 may determine the target charging coefficient of each battery rack 510 (S406) based on Equation 1 below. The target charging coefficient of each battery rack 510 may represent the charging ratio of each battery rack 510 to the total charging power of the energy storage system 10.

$${Ch\_k}_{n} = \frac{\frac{{DOD}_{n}}{100} \times {Q}_{rackn} \times \frac{{SOH}_{n}}{100}}{{\sum }_{i = 1}^{m} \frac{{DOD}_{i}}{100} \times {Q}_{racki} \times \frac{{SOH}_{i}}{100}} = \frac{\frac{{DOD}_{n}}{100} \times {Q}_{rackn} \times \frac{{SOH}_{n}}{100}}{\frac{{DOD}_{total}}{100} \times {Q}_{total} \times \frac{{SOH}_{total}}{100}} \qquad Equation 1$$

In Equation 1, Ch_kₙ may represent the target charging coefficient of an nth battery rack, and DODₙ may represent the discharging state [%] of the n-th battery rack. Q_{rackn} may represent the initial capacity [kWh] of the n-th battery rack, Qₜₒₜₐₗ may represent the total capacity [kWh] of the battery system 500, and SOHₙ may represent the degree of deterioration [%] of the n-th battery rack. Here, m may represent the number of battery racks.

The battery control system 400 may calculate the charging power of each battery rack 510 using the target charging coefficient of each battery rack 510 (S408).

The charging power of each battery rack 510 may be calculated as shown in Equation 2 below.

$${Ch\_P}_{n} = {P}_{total} \times {Ch\_k}_{n} \qquad Equation 2$$

In Equation 2, Ch_Pₙ may represent the charging power [KW] of the n-th battery rack, and Pₜₒₜₐₗ may represent the total charging power of the energy storage system 10.

When the charging power of each battery rack 510 is determined, the battery control system 400 may check whether the charging powers Ch_P of all battery racks 510 are less than or equal to the maximum charging power Pmax_rack of the corresponding battery rack 510 (S410).

When the charging powers Ch_P of all battery racks 510 are less than or equal to the maximum charging power Pmax_rack of the corresponding battery rack 510 (S410, Yes), the battery control system 400 may determine the charging power of each battery rack 510 calculated based on Equation 2 above as the final charging power of each battery rack 510 (S412) as shown in Equation 3 below.

$${Ch\_P}_{n\_ref} = {Ch\_P}_{n} \qquad Equation 3$$

In Equation 3, Ch_Pₙ_ref may represent the final charging power [KW] of the n-th battery rack.

Meanwhile, there may be a case where the charging power of at least one battery rack from among the charging powers of the plurality of battery racks 510 is greater than the maximum charging power of the corresponding battery rack 510. If the charging power of one battery rack 510 is greater than the maximum charging power of the corresponding battery rack 510, damage due to overload may occur in the battery rack 510 or the DC-DC converter 530, and the charging state between the battery racks 510 may also vary. Therefore, the charging powers of the plurality of battery racks 510 may be adjusted as a whole.

If the charging powers of all the battery racks 510 are not less than the maximum charging power of the corresponding battery rack 510 (S410, No), the battery control system 400 may determine a charging power correction coefficient for adjusting the charging powers of the plurality of battery racks 510. The battery control system 400 may calculate the charging coefficient of each battery rack to the maximum charging power of each battery rack (S414) based on Equation 4 below, and may determine the smallest value from among the charging coefficients of battery racks 510 as the charging power correction coefficient (S416) as shown in Equation 5 below.

$${α}_{n} = {P}_{max\_rackn} / {Ch\_P}_{n} \qquad Equation 4$$

$${α}_{x} = MIN ( {α}_{k} ) \qquad Equation 5$$

In Equation 4, an may represent the charging coefficient to the maximum charging power of the n-th battery rack, and P_{max_rackn} may represent the maximum charging power [KW] of the n-th battery rack. In Equation 5, αₓ may represent a charging power correction coefficient, and may be 1≤k≤m, where m may be a positive integer.

The battery control system 400 may adjust the charging power of each battery rack by applying the charging power correction coefficient to the charging power of each battery rack 510 (S418). The adjusted charging power of each battery rack may be calculated as shown in Equation 6 below.

$${Ch\_P}_{n}^{*} = {α}_{x} \times {Ch\_P}_{n} \qquad Equation 6$$

In Equation 6, Ch_Pₙ* may represent the adjusted charging power [KW] of the n-th battery rack.

The battery control system 400 may determine the adjusted charging power of each battery rack 510 calculated based on Equation 6 above as the final charging power of each battery rack 510 (S420) as shown in Equation 7 below.

$${Ch\_P}_{n\_ref} = {Ch\_P}_{n}^{*} \qquad Equation 7$$

The battery control system 400 may provide the final charging power of each battery rack 510 to the PCS 300 and the DC-DC converter 530 of the battery system 500. The battery control system 400 may provide the final charging power of each battery rack 510 to the PCS 300 through the PMS 200.

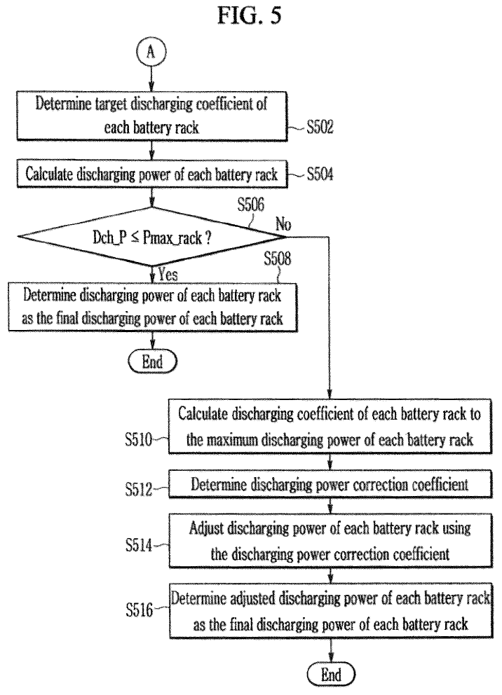

FIG. 5 is a flowchart illustrating a method of determining the discharging power of each battery rack in the battery control system shown in FIG. 2.

Referring to FIG. 5, when the battery control system 400 determines that the operation mode is the discharge mode based on the operation mode information, the battery control system 400 may determine a target discharging coefficient of each battery rack 510 using the total discharging power of the energy storage system 10 and the status information of each battery rack 510 (S502).

The battery control system 400 may determine the target discharging coefficient of each battery rack 510 (S502) based on Equation 8 below. The target discharging coefficient of each battery rack 510 may represent the discharging ratio of each battery rack 510 to the total discharging power of the energy storage system 10.

$${Dch\_k}_{n} = \frac{\frac{{SOC}_{n}}{100} \times {Q}_{{rack}_{n}} \times \frac{{SOH}_{n}}{100}}{{\sum }_{i = 1}^{m} \frac{{SOC}_{i}}{100} \times {Q}_{{rack}_{i}} \times \frac{{SOH}_{i}}{100}} = \frac{\frac{{SOC}_{n}}{100} \times {Q}_{{rack}_{n}} \times \frac{{SOH}_{n}}{100}}{\frac{{SOC}_{total}}{100} \times {Q}_{total} \times \frac{{SOH}_{total}}{100}} \qquad Equation 8$$

In Equation 8, Dch_kₙ may represent the target discharging coefficient of the n-th battery rack, and SOCₙ may represent the charging state [%] of the n-th battery rack. Q_{rackn} may represent the initial capacity [kWh] of the n-th battery rack, Qₜₒₜₐₗ may represent the total capacity [kWh] of the battery system 500, and SOHₙ may represent the degree of deterioration [%] of the n-th battery rack. Here, m may represent the number of battery racks.

The battery control system 400 may calculate the discharging power of each battery rack using the target discharging coefficient of each battery rack 510 (S504). The discharging power of the battery rack may be calculated as shown in Equation 9 below.

$${Dch\_P}_{n} = {P}_{total} \times {Dch\_k}_{n} \qquad Equation 9$$

In Equation 7, Dch_Pₙ may represent the discharging power of the n-th battery rack, and Pₜₒₜₐₗ may represent the total discharging power of the energy storage system 10.

When the discharging power of each battery rack 510 is determined, the battery control system 400 may check whether the discharging powers Dch_P of all battery racks 510 are less than or equal to the maximum discharging power Pmax_rack of the corresponding battery rack 510 (S506).

When the discharging powers Dch_P of all battery racks 510 are less than or equal to the maximum discharging power Pmax_rack of the corresponding battery rack 510 (S506, Yes), the battery control system 400 may determine the discharging power of each battery rack 510 calculated based on Equation 9 above as the final discharging power of each battery rack 510 (S508) as in Equation 10 below.

$${Dch\_P}_{n\_ref} = {Dch\_P}_{n} \qquad Equation 10$$

In Equation 10, Dch_P_{n_ref} may represent the final discharging power [KW] of the n-th battery rack.

Meanwhile, there may be a case where the discharging power of at least one battery rack from among the discharging powers of the plurality of battery racks 510 is greater than the maximum discharging power of the corresponding battery rack 510. If the discharging power of any one battery rack 510 is greater than the maximum discharging power of the corresponding battery rack 510, damage due to overload may occur in the battery rack 510 or the DC-DC converter 530, and the charging state between battery racks 510 may also vary. Therefore, the discharging powers of the plurality of battery racks 510 may be adjusted as a whole.

If the discharging power of all battery racks 510 are not less than the maximum discharging power of the corresponding battery rack 510 (S506, No), the battery control system 400 may determine a discharging power correction coefficient for adjusting the discharging powers of the plurality of battery racks 510. The battery control system 400 may calculate the discharging coefficient of each battery rack to the maximum discharging power of each battery rack (S510) based on Equation 11 below, and may determine the smallest value from among the discharging coefficients of battery racks as the discharging power correction coefficient (S512) as shown in Equation 12 below.

$${α}_{n} = {P}_{max\_rackn} / {Dch\_P}_{n} \qquad Equation 11$$

$${α}_{x} = MIN ( {α}_{k} ) \qquad Equation 12$$

In Equation 11, an may represent the discharging coefficient to the maximum discharging power of the n-th battery rack, and P_{max_rackn} may represent the maximum discharging power [KW] of the n-th battery rack. In Equation 12, ax may represent a discharging power correction coefficient, and may be 1≤k≤m, where m may be a positive integer.

The battery control system 400 may adjust the discharging power of each battery rack by applying the discharging power correction coefficient to the discharging power of each battery rack 510 (S514). The adjusted discharging power of each battery rack may be calculated as Equation 13 below.

$${Dch\_P}_{n}^{*} = {α}_{x} \times {Dch\_P}_{n} \qquad Equation 13$$

In equation 13, Dch_Pₙ* may represent the adjusted discharging power [KW] of the n-th battery rack.

The battery control system 400 may determine the adjusted discharging power of each battery rack 510 calculated based on Equation 13 above as the final discharging power of each battery rack 510 (S516) as shown in Equation 14 below.

$${Dch\_P}_{n\_ref} = {Dch\_P}_{n}^{*} \qquad Equation 14$$

The battery control system 400 may provide the final discharging power of each battery rack 510 to the PCS 300 and the DC-DC converter 530 of the battery system 500. The battery control system 400 may provide the final discharging power of each battery rack 510 to the PCS 300 through the PMS 200.

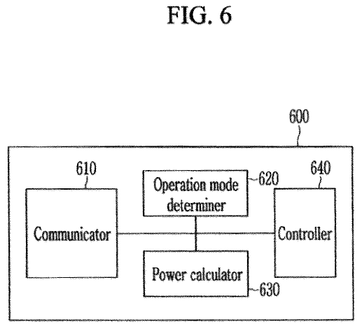

FIG. 6 is a diagram illustrating a battery control system according to an embodiment.

Referring to FIG. 6, the battery control system 600 may include a communicator 610, an operation mode determiner 620, a power calculator 630, and a controller 640.

The communicator 610 may transmit and receive information with the PMS 200 and the battery system 500. The communicator 610 may receive operation mode information from the PMS 200, and transmit status information of the battery system 500 to the PMS 200. The communicator 610 may receive status information from the battery system 500, and transmit information about the operation mode and the output power of each battery rack in the corresponding operation mode to the battery system 500. The output power of each battery rack may represent a charging power in the case of a charge mode, and may represent a discharging power in the case of a discharge mode.

The operation mode determiner 620 may determine the operation mode based on the operation mode information received from the PMS 200.

The power calculator 630 may calculate the output power of each battery rack based on the operation mode determined by the operation mode determiner 620. When the operation mode is the charge mode, the power calculator 630 may calculate the final charging power of each battery rack based on the method shown in FIG. 4. When the operation mode is the discharge mode, the power calculator 630 may calculate the final discharging power of each battery rack based on the method shown in FIG. 5.

The controller 640 may control the operation of the battery system 500 based on the operation mode determined by the operation mode determiner 620 and the output power of each battery rack calculated by the power calculator 630.

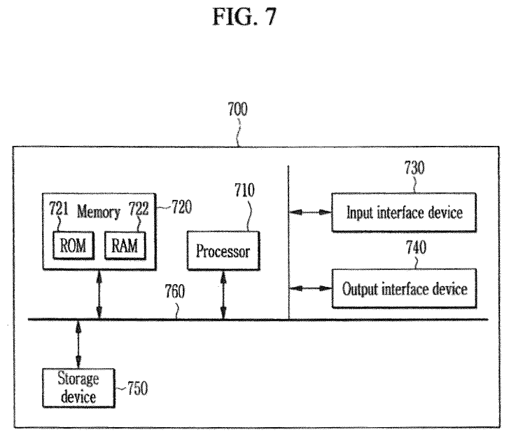

FIG. 7 is a diagram illustrating a battery control system according to another embodiment.

Referring to FIG. 7, the battery control system 700 may represent a computing device in which the battery control methods described above based on FIGS. 4 and 5 are implemented. The battery control system 700 may control the battery system 500 within the energy storage system 10 based on a battery control method.

The battery control system 700 may include at least one of a processor 710, a memory 720, an input interface device 730, an output interface device 740, and a storage device 750. Each component may be connected to one another by a bus 760, and may communicate with one another. Additionally, each component may be connected through an individual interface or individual bus centered on the processor 710, rather than the common bus 760.

The processor 710 may be implemented as various suitable kinds, such as an application processor (AP), a central processing unit (CPU), a graphics processing unit (GPU), and the like, and may be any suitable semiconductor device that executes a command stored in the memory 720 or storage device 750. The processor 710 may execute program commands stored in at least one of the memory 720 and/or the storage device 750. The processor 710 may implement the functions and methods described above based on FIGS. 1 to 6.

Memory 720 and storage device 750 may include various suitable kinds of volatile or non-volatile storage media. For example, the memory 720 may include read-only memory (ROM) 721 and random access memory (RAM) 722. In an embodiment, the memory 720 may be located inside or outside the processor 710, and the memory 720 may be connected to the processor 710 through various suitable means.

The input interface device 730 may be configured to provide data to the processor 710.

The output interface device 740 may be configured to output data from the processor 710.

According to one or more embodiments, independent control of each battery rack may be possible.

According to one or more embodiments, the charging power and discharging power of each battery rack may be determined according to the state of each battery rack, and each battery rack may be individually controlled based on the charging power and discharging power of each battery rack. Therefore, the loss of a usable capacity due to a capacity deviation may be minimized or reduced, and the energy storage system may be operated more stably. The electronic or electric devices and/or any other relevant devices or components according to embodiments of the present disclosure described herein (e.g., the EMS 100, the PMS 200, the PCS 300, the battery control system 400, the operation mode determiner 620, the power calculator 630, the controller 640, and the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

### DESCRIPTION OF SYMBOLS

10: Energy storage system
20: Grid
30: Power generation system
40: Load
100: EMS
200: PMS
300: PCS
400: Battery control system
500: Battery system
510: Battery rack
520: BMS
530: DC-DC converter

What is claimed is:

1. A battery control method for controlling a battery system comprising a plurality of battery racks in a battery control system, the method comprising:
receiving operation mode information of the battery system from an energy management system;
receiving status information of the battery system from the battery system;
determining an individual power of each of the plurality of battery racks based on the operation mode information and the status information; and
adjusting the individual powers of the plurality of battery racks if at least one of the plurality of battery racks has the individual power that exceeds a maximum power of a corresponding battery rack from among the plurality of battery racks.

2. The battery control method as claimed in claim 1, wherein the adjusting of the individual powers of the plurality of battery racks comprises:
determining a power correction coefficient based on the individual powers of the plurality of battery racks and maximum powers of the plurality of battery racks; and
correcting the individual powers of the plurality of battery racks by reflecting the power correction coefficient to the individual powers of the plurality of battery racks.

3. The battery control method as claimed in claim 2, wherein the determining of the power correction coefficient comprises:
calculating a ratio of the individual power to the maximum power of each of the plurality of battery racks; and
determining a smallest value from among the ratios of the individual powers to the maximum powers of the plurality of battery racks as the power correction coefficient.

4. The battery control method as claimed in claim 2, wherein:
if the operation mode information indicates a charge mode, the individual power indicates a charging power; and
if the operation mode information indicates a discharge mode, the individual power indicates a discharging power.

5. The battery control method as claimed in claim 1, wherein:
the operation mode information comprises at least one of charge mode information or discharge mode information; and
the status information comprises at least one of a status of charge (SOC), a status of health (SOH), or a depth of discharge (DOD) of each of the plurality of battery racks.

6. The battery control method as claimed in claim 5, wherein the charge mode information comprises a total charging power of the battery system, and
wherein the determining of the individual power comprises:
determining a target charging coefficient representing a charging rate of each of the plurality of battery racks using the DOD and the SOH of each of the plurality of battery racks; and
calculating an individual charging power of each of the plurality of battery racks based on the total charging power of the battery system and the target charging coefficient of each of the plurality of battery racks.

7. The battery control method as claimed in claim 5, wherein the discharge mode information comprises a total discharging power of the battery system, and
wherein the determining of the individual power comprises:
determining a target discharging coefficient representing a discharge rate of each of the plurality of battery racks using the SOC and the SOH of each of the plurality of battery racks; and
calculating an individual discharging power of each of the plurality of battery racks based on the total discharging power of the battery system and the target discharging coefficient of each of the plurality of battery racks.

8. A battery control system to control a battery system comprising a plurality of battery racks, the battery control system comprising:
a communicator configured to receive operation mode information of the battery system and status information of the battery system;
an operation mode determiner configured to determine an operation mode of the battery system based on the operation mode information; and
a power calculator configured to:
determine an individual power of each of the plurality of battery racks corresponding to the operation mode based on the status information; and
determine whether to adjust the individual power of each of the plurality of battery racks based on the individual power of each of the plurality of battery racks and a maximum power of each of the plurality of battery racks.

9. The battery control system as claimed in claim 8, wherein the power calculator is configured to determine final powers of the plurality of battery racks by adjusting the individual powers of the plurality of battery racks if at least one of the plurality of battery racks has the individual power that exceeds a maximum power of a corresponding battery rack.

10. The battery control system as claimed in claim 9, wherein the power calculator is configured to:
determine a power correction coefficient based on the individual powers of the plurality of battery racks and maximum powers of the plurality of battery racks; and
reflect the power correction coefficient to the individual powers of the plurality of battery racks to determine the final powers of the plurality of battery racks.

11. The battery control system as claimed in claim 10, wherein the power calculator is configured to:
calculate a ratio of the individual power to the maximum power of each of the plurality of battery racks; and
determine a smallest value of the ratios of the individual powers to the maximum powers of the plurality of battery racks as the power correction coefficient.

12. The battery control system as claimed in claim 9, wherein the power calculator is configured to determine the individual power of each of the plurality of battery racks as the final power of each of the plurality of battery racks, respectively, if the individual power of each of the plurality of battery racks does not exceed the maximum power of each of the plurality of battery racks.

13. The battery control system as claimed in claim 8, wherein:
the operation mode information comprises at least one of charge mode information or discharge mode information; and
the status information comprises at least one of a status of charge (SOC), a status of health (SOH), or a depth of discharge (DOD) of each of the plurality of battery racks.

14. The battery control system as claimed in claim 13, wherein the charge mode information comprises a total charging power of the battery system, and
wherein the power calculator is configured to:
determine a target charging coefficient representing a charging rate of each of the plurality of battery racks using the DOD and the SOH of each of the plurality of battery racks; and
calculate an individual charging power of each of the plurality of battery racks based on the total charging power of the battery system and the target charging coefficient of each of the plurality of battery racks.

15. The battery control system as claimed in claim 13, wherein the discharge mode information comprises a total discharging power of the battery system, and
wherein the power calculator is configured to:
determine a target discharging coefficient representing a discharge rate of each of the plurality of battery racks using the SOC and the SOH of each of the plurality of battery racks; and
calculate an individual discharging power of each of the plurality of battery racks based on the total discharging power of the battery system and the target discharging coefficient of each of the plurality of battery racks.
